(19) United States
(12) Patent Application Publication
(10) Pub. No.: US 2009/0138825 A1
(43) Pub. Date: May 28, 2009

(54) Image navigation apparatus and method

(76) Inventor: Matias Duarte, San Francisco, CA (US)

Correspondence Address: MICROSOFT CORPORATION, ONE MICROSOFT WAY, REDMOND, WA, 98052, US

(21) Appl. No.: 10/262,442

(22) Filed: Sep. 30, 2002

(51) Int. Cl. G06F 3/048

(52) U.S. Cl. 715/838

(57) ABSTRACT

A graphical user interface (“GUI”) for managing a set of images is described comprising: a thumbnail region for displaying a first group of thumbnail images; a highlight element to highlight a specified one of the first group of thumbnail images responsive to user input; and a navigation map positioned adjacent to the thumbnail region for graphically displaying an indication of the particular thumbnail image currently being highlighted and further graphically displaying a positional relationship between the first group of thumbnail images and a second group of thumbnail images not currently displayed in the thumbnail region.

### BACKGROUND

1. Field of the Invention

This invention relates generally to the field of image processing applications. More particularly, the invention relates a to graphical user interface used for viewing and processing images such as photographs.

2. Description of the Related Art

Portable data processing devices such as Personal Digital Assistants (“PDAs”) and programmable wireless telephones are becoming more powerful every day, providing users with a wide range of applications previously only available on personal computers. At the same time, due to advances in silicon processing technology and battery technology, these devices may be manufactured using smaller and smaller form factors. Accordingly, users no longer need to sacrifice processing power for portability when selecting a personal data processing device.

Although processing devices with small form factors tend to be more portable, users may find it increasingly difficult to interact with them. For example, entering data may be difficult due to the absence of a full-sized keyboard and reading information may be difficult due to a small, potentially dim Liquid Crystal Display (“LCD”). Moreover, navigating through complex menu hierarchies, directory structures and documents may be difficult without the use of a full-functioned mouse or other cursor control device.

One type of application which may be particularly problematic on a device with limited screen space and input functionality is photo/image processing. Current photo management and photo processing applications typically allow users to concurrently view thumbnails representing a series of photos stored in a particular directory. To view a full screen image of a specific photo, the user may select the thumbnail of the photo using a mouse. Given the fact that users are frequently capturing and storing personal photos on portable data processing devices, what is needed are new navigation techniques and graphical user interface features to aid in navigating through photographs on a data processing device.

### SUMMARY

A graphical user interface (“GUI”) for managing a set of images is described comprising: a thumbnail region for displaying a first group of thumbnail images; a highlight element to highlight a specified one of the first group of thumbnail images responsive to user input; and a navigation map positioned adjacent to the thumbnail region for graphically displaying an indication of the particular thumbnail image currently being highlighted and further graphically displaying a positional relationship between the first group of thumbnail images and a second group of thumbnail images not currently displayed in the thumbnail region.

### BRIEF DESCRIPTION OF THE DRAWINGS

A better understanding of the present invention can be obtained from the following detailed description in conjunction with the following drawings, in which:

FIG. 1a-d illustrate an exemplary data processing device on which embodiments of the invention are implemented.

FIG. 2 illustrates one embodiment of a primary menu structure for selecting an application.

FIG. 3 illustrates a graphical navigation interface for navigating through photographs according to one embodiment of the invention.

FIG. 4 illustrates additional embodiments of the graphical navigation interface.

FIG. 5 a full screen view employed in one embodiment of the graphical navigation interface.

FIG. 6 illustrates additional embodiments of the graphical navigation interface.

FIG. 7 illustrates menu features provided in one embodiment of the invention.

### DETAILED DESCRIPTION OF PREFERRED EMBODIMENTS

Described below is a system and method for integrating personal information management and messaging applications. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

### An Exemplary Data Processing Device

Embodiments of the invention may be implemented on a data processing device such as that described in co-pending application entitled ADJUSTABLE DATA PROCESSING DISPLAY, Ser. No. 09/714,320, Filed Nov. 15, 2000, which is assigned to the assignee of the present application and which is incorporated herein by reference. Certain embodiments of such a data processing device will now be described followed by a detailed description of an image navigation apparatus and method. It should be noted, however, that the specific data processing device described below is not required for implementing the underlying principles of the invention. Rather, the invention may be implemented on virtually any type of data processing device including standard personal computers, personal digital assistants and wireless telephones.

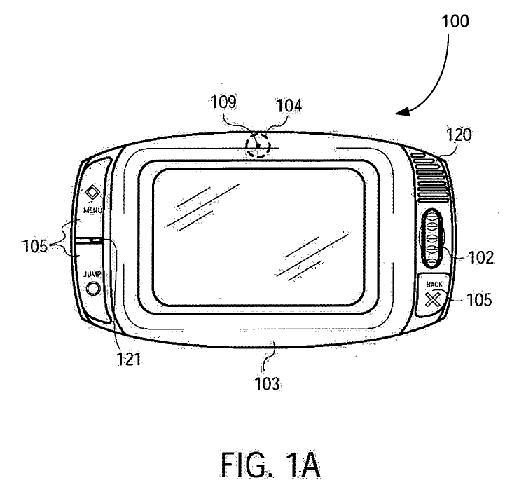

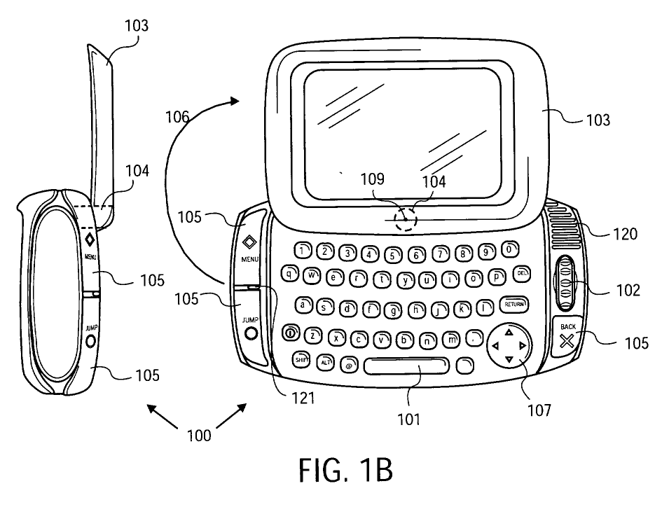

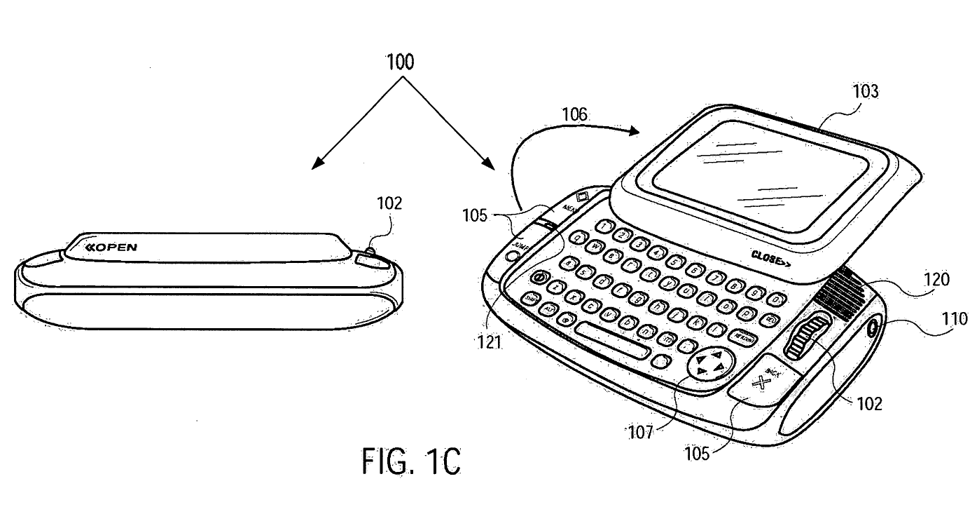

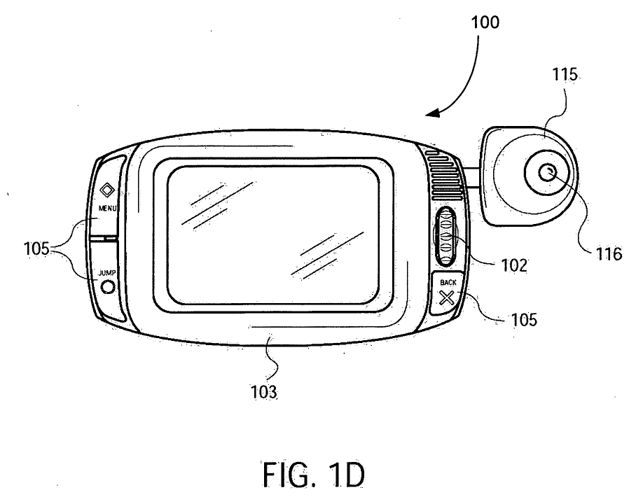

FIGS. 1a-d illustrate a data processing device 100 with an adjustable display 103 according to one embodiment of the invention. In one embodiment, the data processing device 100 is comprised of a keyboard 101, a control knob/wheel 102 (e.g., for scrolling between menu items and/or data), and a set of control buttons 105 (e.g., for selecting menu items and/or data).

In one embodiment, the display 103 is pivotally coupled to the data processing device 100. More specifically, the display 103 pivots around a pivot point 109, located within a pivot area 104, from a “closed” position illustrated in FIG. 1a to an “open” position illustrated in FIGS. 1b-c. When in a closed position, the display 103 covers the keyboard 101 thereby decreasing the size of the device 100 and protecting the keyboard 101. Even when the display is in a closed position, however, the control knob 102 and control buttons 105 are exposed and therefore accessible by the user. The motion of the display 103 from a closed position to an open position is indicated by motion arrow 106 illustrated in FIGS. 1b-c. As illustrated, when in an open position, the keyboard 101 is fully exposed. Accordingly, it will be appreciated that the display is viewable, and data is accessible by the user in both an open and a closed position (although access to the keyboard is only provided in an open position).

In one embodiment, a switch within the device 100 (not shown) is triggered when the display 103 is moved from one position to the next. Hardware/software within the device may be configured to read the position of the switch and invert images rendered on the display based on the switch position. Accordingly, images are rendered on the display 103 right-side-up, regardless of whether the display 103 is in an open or a closed position. In addition, in one embodiment, a different user interface (or other operating systems functions) may be triggered by the switch. For example, when the display is moved into a closed position, a user interface may be displayed which is more easily navigable with only the control buttons 105 and control knob 102 (i.e., without the use of the keyboard 101). Various other interface functions may be triggered by the switch consistent with the underlying principles of the invention. Moreover, various different types of switches may be employed on the device 100 including standard mechanical switches, electrical switches (e.g., capacitive/magnetic switches), or any combination thereof.

If standard electrical wiring is used to electrically couple the data processing device 100 and the display 103, the pivot area 104 should be wide enough to accommodate the wiring. However, various different types of electrical connections may be employed between the data processing device 100 and the display 103 while still complying with the underlying principles of the invention. For example, in one embodiment, the display 103 may be communicatively coupled to the processing device 100 via a wireless connection (e.g., using the Bluetooth standard, IEEE 802.11b, a capacitive coupling, . . . etc). If configured with a wireless connection, the display 103 may be detachable from the processing device 100.

Moreover, various types of physical connections may be used to rotatably mount the display 103 to the processing device 100. For example, in one embodiment, the device 100 is cooperatively mated to the display 103 with a set of circular guide rails or tracks (not shown).

The control knob 102 and control buttons 105 may be programmed to perform various functions within applications executed on the processing device 100. For example, if an email client application is executed on the device 100, the control knob 102 may be configured to scroll through the list of email messages within the user's inbox (e.g., with the current email message highlighted on the display 103). One of the control buttons 105 may be configured to select a particular email message within the list. A second control button may be configured as a “back” button, allowing the user to back out of selected email messages and/or to move up through the menu/folder hierarchy. A third control button may be configured to bring the user to a desired location within the email application (e.g., to the top of the menu/folder hierarchy) or within the operating system executed on the processing device 100.

In one embodiment, the functions to be executed by the buttons 105 and control knob 102 may be programmed by the end-user. In addition, various different control elements may be employed on the processing device 100 while still complying with the underlying principles of the invention.

In one embodiment, a cursor control element 107 is provided within the keyboard 101. The cursor control element 107 acts like a typical set of control keys, providing for movement of a cursor in any direction specified by the user (i.e., up, down, left and right).

In one embodiment, the data processing device 100 is also provided with audio telephony (e.g., cellular) capabilities. To support audio telephony functions, the embodiment illustrated in FIGS. 1a-d includes a speaker 120 for listening and a microphone 121 for speaking during a telephone conversation. Notably, the speaker 120 and microphone 121 are positioned at opposite ends of the data processing device 100 and are accessible when the screen 103 is in a closed position and an open position.

As illustrated in FIG. 1d, one embodiment of the data processing device 100 also includes a detachable camera 115 for capturing images. In FIG. 1d, the lens 116 of the camera 115 is facing out of the plane of the figure. The camera may be inserted into an input port 110 such as that shown in FIG. 1c, and may be rotatable around an axis defined by the input orientation of the input port. In one embodiment, the input port 110 is the same port as that used to communicatively couple a telephone headset (now shown) to the data processing device 100.

The images captured via the camera 115 may be stored on a non-volatile memory such as flash memory or a hard drive. Control of the camera 115 and processing of the stored images may be provided via the image/photo processing and camera application described in detail below.

### Apparatus and Method for Image Navigation

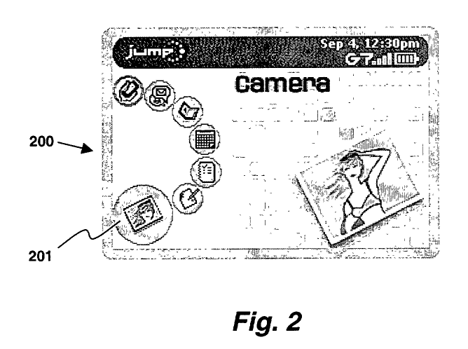

FIG. 2 illustrates a primary menu structure 200 employed on one embodiment of the data processing device 110. Each icon within the primary menu structure 200 represents a different application. The user may scroll through the icons within the primary menu structure 200 to locate the image processing/camera application 201 which employs the image navigation features described herein.

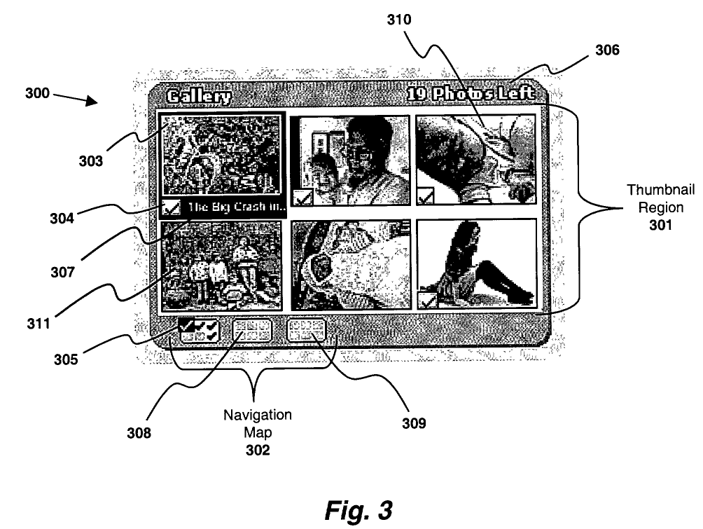

As illustrated in FIG. 3, one embodiment of the image processing/camera application 201 includes a graphical navigation interface 300. The graphical navigation interface 300 is comprised of a thumbnail region 301 and a graphical navigation map 302. The thumbnail region 301 is comprised of a plurality of thumbnail images captured via the camera 115 and/or downloaded from another data processing device (e.g., a personal computer or server). In the embodiment shown in FIG. 3, six thumbnail images are viewable at a time. However, the underlying principles of the invention are not limited to any particular number of viewable images per screen.

In the particular example shown in FIG. 3, photo 303 is currently selected by the user as indicated by a black highlight graphic 307 surrounding the photo 303. When highlighted, the title of the photo appears within the highlight graphic 307, as indicated. Also shown within the highlight graphic 307 is a selection box 304 in which the user may place a check mark to select the photo 307 for a specified operation (e.g., copy, cut, delete, . . . etc).

The navigation map 302 provides a graphical indication of the individual photo(s) highlighted via the highlight graphic 307 and selected via the selection box 304 within each group of six. For example, based on the position of the highlighted thumbnail icon 305, the user can easily discern that the highlighted thumbnail image 303 is located within the upper left corner of the first set of six photos (i.e., the “first” set in that it is the leftmost set). As the user moves the highlight graphic 307 throughout the thumbnail images, the highlight graphic within the navigation map 302 moves accordingly. As illustrated, in one embodiment, the highlight graphic 305 within the navigation map 302 will appear enlarged relative to the non-highlighted thumbnail image icons.

The user may scroll the highlight graphic 307 through the different photographs via the control knob 102 and/or the cursor control element 107. Specifically, in one embodiment, scrolling in a downward direction on the control knob 102 or to the right via the cursor control element 107 causes the highlight to jump, in succession, to the right, through each of the three thumbnail images at the top of the first set of six. Once the highlight graphic 307 reaches the rightmost top thumbnail 310, it will drop down to the bottom row of thumbnail images, starting with the leftmost thumbnail image 311. A continued downward motion of the control knob 102 and/or rightward selection on the cursor control element 107 will cause the highlight graphic 307 to proceed to the right across the bottom row. Once it reaches the rightmost thumbnail 312 on the bottom row, continued downward/rightward motion of the control knob 102/cursor control element 107 causes the six viewable thumbnail images to be replaced with the next six thumbnail images in the user's image library (i.e., those represented as image set 308 in the navigation map 302). The highlight graphic 307 will then appear over the leftmost top thumbnail image of the second group of thumbnail images and the motion of the highlight graphic will continue substantially as just described (i.e., across the top row and then the bottom row of the second set in response to a downward movement of the control knob 102 or rightward selection of the cursor control element 107).

An upward movement of the control knob 102 and a leftward selection on the cursor control element 107 will cause the highlight graphic to move in the opposite direction across the different sets of thumbnail images as that just described (e.g., from right to left across the bottom and then from right to left across the top). Thus, the navigation map 302 provides an intuitive graphical user interface for navigating through a plurality of photographs.

In one embodiment, however, the cursor control element 107 will move the highlight graphic 307 through the thumbnails in a different manner than the control knob 102. Specifically, in this embodiment, the highlight element 107 does not necessarily pass through the lower row of thumbnail images before moving to the next set. For example, when the highlight graphic 307 is highlighting the rightmost top photo 310, a continued rightward motion via the cursor control element 107 will bring up the second set of photos 308, with the photo in the upper left corner of the second set being highlighted initially. Thus, starting from the position illustrated in FIG. 3, three cursor movements to the right via the cursor control element 107 will bring up the second set of photos 308, and another three cursor movements to the right will bring up the third set of photos, again with the photo in the upper left corner of the third set being highlighted initially. The same type of motion is provided via the bottom row of thumbnail icons (e.g., the highlight element will move through each of the bottom rows of each set of photos in succession). Thus, the user may jump from one set of photos to the next more quickly with the cursor control element 107. Moreover, using an upward or downward selection on the cursor control element 107 will cause the highlight graphic 307 to jump directly to the top row from any position on the bottom row and to jump directly to the bottom row from any position on the top row (e.g., even from the middle top/bottom thumbnail in a particular group).

When a particular thumbnail image is highlighted, the user may select the thumbnail image via the selection boxes 304 corresponding to the thumbnail image. The user may place a check in a particular selection box via a specified control element 105 or alphanumeric key from the keyboard 101. As the user continues to select thumbnail images via the selection boxes 304 in this manner, selection indications (e.g., check marks) will appear in corresponding thumbnail icons within the navigation map 302 (e.g., such as highlighted thumbnail icon 305).

Once a set of thumbnail images have been selected, a specified operation may be performed on the entire group such as, by way of example but not limitation, an operation to send the selected group in an e-mail message, a compression operation, a resizing operation, a deletion of all selected images, a move operation on all selected images, . . . etc.

In one embodiment, to check a number of contiguous photos or all photos in the set, the user may highlight the first photo in the series, hold the Shift key down on the keyboard 101 while clicking the control knob 102. Then while still holding down the Shift key the user can scroll to the final photo in the series and click the push wheel a final time. All photos between the first and last clicked will be selected (including the first and last).

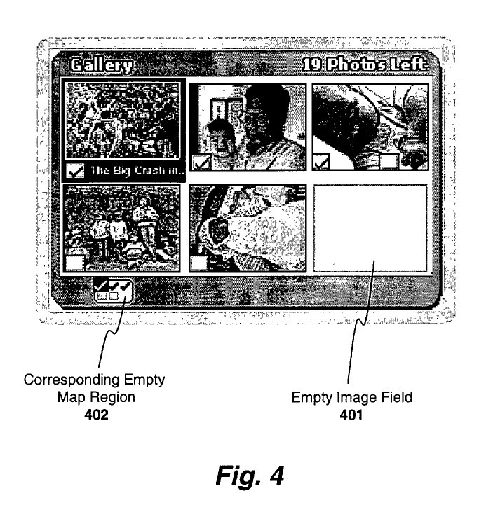

As illustrated in FIG. 4, in one embodiment, when a particular set of thumbnail images does not include the standard number of images (e.g., six in the example described herein) then an empty image graphic 401 will be displayed within the thumbnail region 301, and a corresponding empty image graphic 402 will be displayed within the navigation map 302.

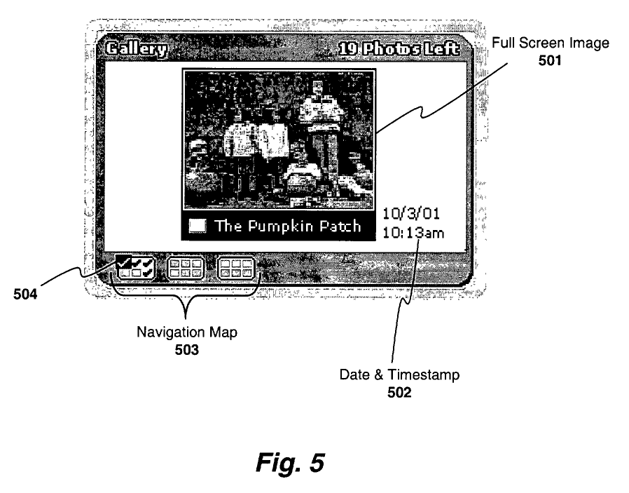

The user may view a thumbnail image as a full-screen image 501 such as that shown in FIG. 5 by highlighting the thumbnail image via the highlight graphic 307 and performing a specified user input function (e.g., selecting a specified control element 105 or alphanumeric key from the keyboard 101 or by depressing the control knob 102). One embodiment of the full-screen image 501 includes a title for the image (if one is available) and an indication of the date and time that the image was captured 502.

As illustrated, in one embodiment, even when in full-screen mode the navigation map 503 is still viewable, as is a highlight indication 504 for the currently-selected full-screen image. Moreover, the user may jump from one image to the next in the same manner as described above (e.g., using the control elements 105 or control knob 102). The highlight indication 504 will move accordingly within the navigation map 503. In full screen mode, however, only the selected, full-screen image will appear on the screen.

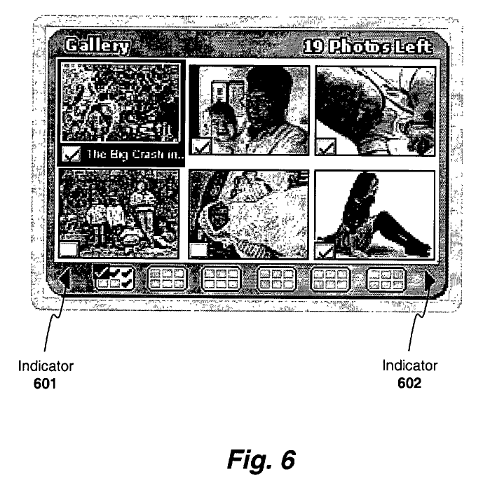

As illustrated in FIG. 6, if the user has a significant number of stored thumbnail images, then left and right indicators 601 and 602, respectively, are provided to indicate that additional groups of thumbnail images are available outside of the viewable portion of the navigation map. The user may navigate to the off-screen portions of the navigation map in the same manner as described above (e.g., via manipulation of the control knob 102 and/or cursor control element 107).

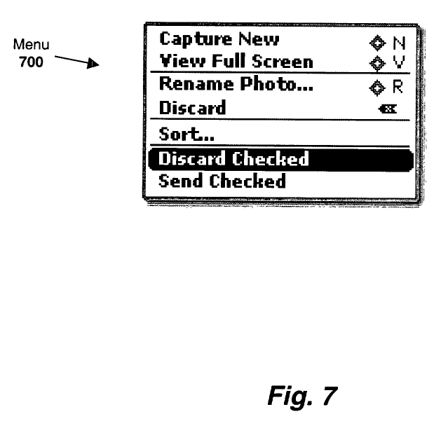

In one embodiment, the user may bring up an image processing application menu by selecting a specified control element 105 or key form the keyboard 101. As illustrated in FIG. 7, one embodiment of the application menu 700 is comprised of the following menu items. A “Capture New” item causes the application to enter capture mode, wherein the user may capture new photographs via the detachable camera 115. A “View Full Screen” option causes the application to enter full-screen mode (as described above). In one embodiment, the currently highlighted thumbnail image will then be viewed in a full-screen. “Rename Photo” allows the user to provide a new name for the highlighted image and “Discard” causes the highlighted image to be deleted from the data processing device. “Sort” allows the user to sort images based on various specified criteria (e.g., alphabetically, by date, by size, . . . etc) and “Discard Checked” and “Send Checked” cause a group of checked images to be deleted or sent to a specified destination (e.g., via an e-mail message). Various additional commands may be provided on the menu 700 while still complying with the underlying principles of the invention.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media suitable for storing or transmitting electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

1. A graphical user interface (“GUI”) for managing a set of images comprising:
a thumbnail region for displaying a first group of thumbnail images;
a highlight element to highlight a specified one of said first group of thumbnail images responsive to a user input device;
a selection graphic associated with each of said thumbnail images to indicate which of said images have been selected by a user, wherein said selection graphic appears within and/or substantially proximate to said thumbnail image as a consequence of said user's action to highlight said thumbnail image and said selection graphic contains information specific to said highlighted thumbnail image including at least a graphical check box which may be selectively checked or unchecked by said user; and
a navigation map positioned adjacent to said thumbnail region for graphically displaying:
an indication of a plurality of groups of thumbnail images, each group of said plurality discernable from one another and displayable in said thumbnail region at one time, said plurality of groups including:
said first group of thumbnail images displayed on said thumbnail region; and
a second group of thumbnail images that are not currently displayed in said thumbnail region;
an indication of a particular thumbnail image currently being highlighted;
an indication of particular thumbnail images currently selected by said user; and
a positional relationship between said first group of thumbnail images and said second group of thumbnail images.

2.-3. (canceled)

4. The GUI as in claim 1 wherein said user input device is a control knob.

5. The GUI as in claim 4 wherein said thumbnail images are arranged in a top row and a bottom row and wherein scrolling said control knob in a first direction causes said highlight element to move sequentially from left to right over each of said thumbnail images in said top row and then to move sequentially from left to right over each of said thumbnail images in said bottom row.

6. The GUI as in claim 5 wherein when said highlight element reaches a rightmost thumbnail image in said bottom row, further scrolling of said control knob in said first direction causes said second group of thumbnail images to be displayed in said thumbnail region in place of said first group of thumbnail images.

7. The GUI as in claim 6 wherein when said second group of thumbnail images is displayed, said highlight region initially highlights a thumbnail image in a leftmost position of said top row.

8. The GUI as in claim 1 wherein said user input device is a cursor control element or a set of cursor control keys.

9. The GUI as in claim 1 further comprising:
an empty image field in said thumbnail region where no thumbnail image exists; and
a corresponding empty image indication in said navigation map.

10. The GUI as in claim 1 further comprising:
an indicator associated with said navigational map to indicate that portions of said navigational map are not currently viewable, said indicator further indicating a relative position of said portions of said navigation map.

11. An article of manufacture including program code which, when executed by a machine, causes said machine to generate a graphical user interface (“GUI”) comprising:
a thumbnail region for displaying a first group of thumbnail images;
a highlight element to highlight a specified one of said first group of thumbnail images responsive to a user input device;
a selection graphic associated with each of said thumbnail images to indicate which of said images have been selected by a user, wherein said selection graphic appears within and/or substantially proximate to said thumbnail image as a consequence of said user's action to highlight said thumbnail image and said selection graphic contains information specific to said highlighted thumbnail image including at least a graphical check box which may be selectively checked or unchecked by said user; and
a navigation map positioned adjacent to said thumbnail region for graphically displaying:
an indication of a plurality of groups of thumbnail images, each group of said plurality discernable from one another and displayable in said thumbnail region at one time, said plurality of groups including:
said first group of thumbnail images displayed on said thumbnail region; and
a second group of thumbnail images that are not currently displayed in said thumbnail region;
an indication of a particular thumbnail image currently being highlighted;
an indication of particular thumbnail images currently selected by said user; and
a positional relationship between said first group of thumbnail images and said second group of thumbnail images.

12.-13. (canceled)

14. The article of manufacture as in claim 11 wherein said user input device is a control knob.

15. The article of manufacture as in claim 14 wherein said thumbnail images are arranged in a top row and a bottom row and wherein scrolling said control knob in a first direction causes said highlight element to move sequentially from left to right over each of said thumbnail images in said top row and then to move sequentially from left to right over each of said thumbnail images in said bottom row.

16. The article of manufacture as in claim 15 wherein when said highlight element reaches a rightmost thumbnail image in said bottom row, further scrolling of said control knob in said first direction causes said second group of thumbnail images to be displayed in said thumbnail region in place of said first group of thumbnail images.

17. The article of manufacture as in claim 16 wherein when said second group of thumbnail images is displayed, said highlight region initially highlights a thumbnail image in a leftmost position of said top row.

18. The article of manufacture as in claim 11 wherein said user input device is a cursor control element or a set of cursor control keys.

19. The article of manufacture as in claim 11 including additional program code to cause said machine to generate a GUI further comprising:
an empty image field in said thumbnail region where no thumbnail image exists; and
a corresponding empty image indication in said navigation map.

20. The article of manufacture as in claim 11 including additional program code to cause said machine to generate a GUI further comprising:
an indicator associated with said navigational map to indicate that portions of said navigational map are not currently viewable, said indicator further indicating a relative position of said portions of said navigation map.

21. A system for processing graphical images comprising:
combining means for combining said graphical images into a thumbnail region for displaying a first group of thumbnail images;
highlight movement means for moving a highlight element to highlight a specified one of said first group of thumbnail images responsive to a means for receiving user input;
a selection graphic associated with each of said thumbnail images to indicate which of said images have been selected by a user, wherein said selection graphic appears within and/or substantially proximate to said thumbnail image as a consequence of said user's action to highlight said thumbnail image and said selection graphic contains information specific to said highlighted thumbnail image including at least a graphical check box which may be selectively checked or unchecked by said user; and
navigation map indication means for moving an indication of the particular thumbnail image currently being highlighted within a navigation map positioned adjacent to said thumbnail region, said moving of said indication occurring concurrently with said moving of said highlight element, said navigational map indication means further graphically displaying within said navigational map:
an indication of a plurality of groups of thumbnail images, each group of said plurality discernable from one another and displayable in said thumbnail region at one time, said plurality of groups including:
said first group of thumbnail images displayed on said thumbnail region; and
a second group of thumbnail images that are not currently displayed in said thumbnail region;
an indication of a particular thumbnail image currently being highlighted;
an indication of particular thumbnail images currently selected by said user; and
a positional relationship between said first group of thumbnail images and said second group of thumbnail images.

22.-23. (canceled)

24. The system as in claim 21 wherein said means for receiving user input comprises a control knob.

25. The system as in claim 24 wherein said thumbnail images are arranged in a top row and a bottom row and wherein scrolling said control knob in a first direction causes said highlight element to move sequentially from left to right over each of said thumbnail images in said top row and then to move sequentially from left to right over each of said thumbnail images in said bottom row.

26. The system as in claim 25 wherein when said highlight element reaches a rightmost thumbnail image in said bottom row, further scrolling of said control knob in said first direction causes said second group of thumbnail images to be displayed in said thumbnail region in place of said first group of thumbnail images.

27. The system as in claim 26 wherein when said second group of thumbnail images is displayed, said highlight region initially highlights a thumbnail image in a leftmost position of said top row.

28. The system as in claim 21 wherein said user input device is a cursor control element or a set of cursor control keys.

29. The system as in claim 21 further comprising:
empty image field indication means in said thumbnail region where no thumbnail image exists; and
a corresponding empty image indication means within said navigation map.

30. The system as in claim 21 further comprising:
hidden navigational map means associated with said navigational map to indicate that portions of said navigational map are not currently viewable, said hidden navigational map means further indicating a relative position of said portions of said navigation map.
